(19) United States
(12) Patent Application Publication
(10) Pub. No.: US 2007/0061413 A1
(43) Pub. Date: Mar. 15, 2007

(54) System and method for obtaining user information from voices

(76) Inventors: Eric J. Larsen, Foster City, CA (US); Ruxin Chen, Redwood City, CA (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/400,997

(22) Filed: Apr. 10, 2006

Related U.S. Application Data
(60) Provisional application No. 60/718,145, filed on Sep. 15, 2005.

(51) Int. Cl. G06F 15/16

(52) U.S. Cl. 709/217

(57) ABSTRACT

A system and method of displaying content to a user depending on whether the user's speech indicates the user is sufficiently mature to view the content.

### CROSS-REFERENCE TO RELATED APPLICATIONS

The present application claims the benefit of U.S. Provisional Patent Application No. 60/718,143 filed Sep. 15, 2005, and the disclosure of such application is hereby incorporated by reference.

### BACKGROUND OF THE INVENTION

Many video games already contain Entertainment Software Rating Board (ESRB) ratings that are designed to provide information about video and computer game content, thus allowing people to make informed purchase decisions. The ESRB ratings typically include rating symbols that suggest age appropriateness for the game.

However, many game developers and purchasers desire a greater degree of control. For example, in some households, the games may be kept in place that can be reached and used by younger children.

There have been prior attempts to provide greater control over content in other areas, such as the “V-Chip” in television receivers. In that regard, the FCC has adopted rules requiring all television sets with picture screens 33 centimeters (13 inches) or larger to be equipped with features to block the display of television programming based upon its rating. The V-Chip reads information encoded in the rated program and blocks programs from the set based upon the rating selected by the parent. However, if a household has enabled a television to be viewed by its older children, then the television will still be available for viewing by the younger children. Moreover, if a young child becomes aware of the password, the child can use the password to avoid the protections selected by the parent.

Accordingly, it would be advantageous if there were a system and method which provided greater control over the content of video games based on the maturity of the user.

### SUMMARY OF THE INVENTION

In one aspect, the present invention provides a system and method which permits the display of game content based on an analysis of the user's speech. The analysis comprises processing the speech in order to determine the user's maturity. If the speech indicates that the user is sufficiently mature, then age-restricted content, which may comprise anywhere from a portion to the entire game, is displayed.

Other aspects of the present invention are described below.

### BRIEF DESCRIPTIONS OF THE DRAWINGS

FIG. 1 is a functional diagram of a system in accordance with an aspect of the present invention.

FIG. 2 is a diagram of a method in accordance with an aspect of the present invention.

FIG. 3 is a screen shot in accordance with an aspect of the present invention.

### DETAILED DESCRIPTION

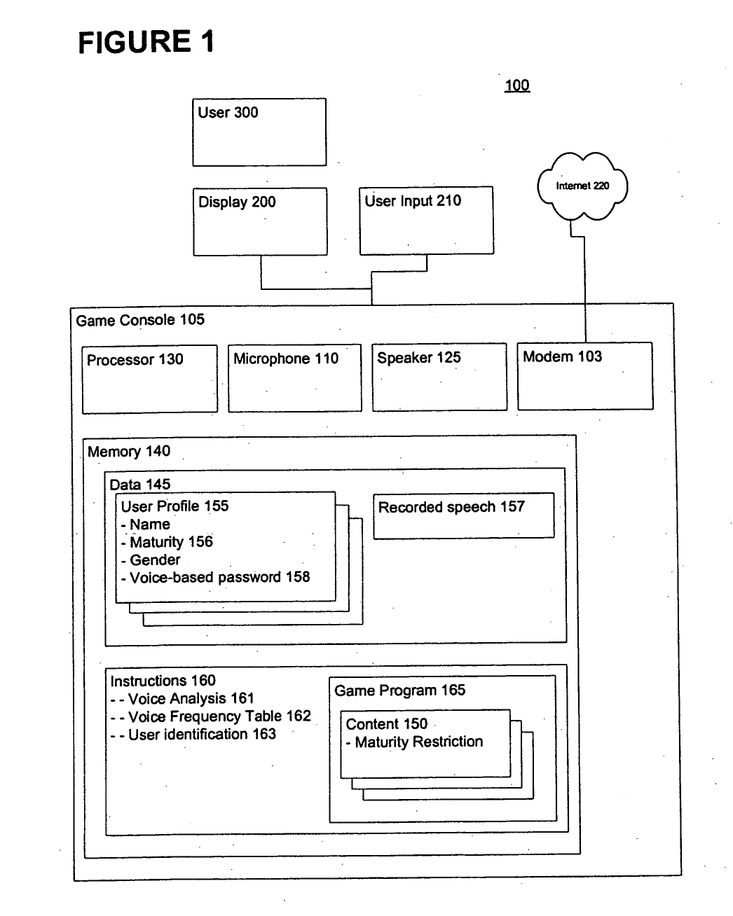

As shown in FIG. 1, a system 100 in accordance with one aspect of the invention comprises a game console 105, display 200, user input 210 and other components typically present in game consoles. The system is used by a user, indicated as user 300.

Game console 105 preferably includes a processor 130 and memory 140. Memory 140 stores information accessible by processor 130, including instructions 160 for execution by the processor 130 and data 145 which is retrieved, manipulated or stored by the processor. The memory may be of any type capable of storing information accessible by the processor; by way of example, hard-drives, ROM, RAM, CD-ROM, DVD, write-capable memories, and read-only memories.

The instructions 160 may comprise any set of instructions to be executed directly (e.g., machine code) or indirectly (e.g., scripts) by the processor. The terms “instructions,” “steps” and “programs” may be used interchangeably herein. The functions, methods and routines of the program in accordance with the present invention are explained in more detail below.

Data 145 may be retrieved, stored or modified by processor 130 in accordance with the instructions 160. The data may be stored in any manner known to those of ordinary skill in the art such as in computer registers, in records contained in tables and relational databases, or in XML files. The data may also be formatted in any computer readable format such as, but not limited to, binary values, ASCII or EBCDIC (Extended Binary-Coded Decimal Interchange Code). Moreover, any information sufficient to identify the relevant data may be stored, such as descriptive text, proprietary codes, pointers, or information which is used by a function to calculate the relevant data.

Although the processor and memory are functionally illustrated in FIG. 1 as within the same block, it will be understood by those of ordinary skill in the art that the processor and memory may actually comprise multiple processors and memories that may or may not be stored within the same physical housing. For example, some or all of the instructions and data may be stored on a removable CD-ROM and others within a read-only computer chip. Some or all of the instructions and data may be stored in a location physically remote from, yet still accessible by, the processor. Similarly, the processor may actually comprise a collection of processors which may or may not operate in parallel.

As noted above, system 100 may comprise additional components typically found in a computer system such as a display 200 (e.g., an LCD screen), user input 210 (e.g., a keyboard, mouse, game pad, touch-sensitive screen), microphone 110, modem 103 (e.g., telephone or cable modem), and all of the components used for connecting these elements to one another. Game console 105 preferably communicates with the Internet 220 via modem 103 or some other communication component such as a network card.

Instead of a game console, the system may also comprise any device capable of processing instructions and transmitting data to and from humans and other computers, including general purpose computers, network computers lacking local storage capability, PDA's with modems and Internet-capable wireless phones.

In one aspect of the present invention, instructions 160 comprise a game program, such as a game stored on a DVD-ROM or downloaded to the console 105 via modem 105 from the Internet 220. The instructions 160 also comprise routines stored within the console 105 which are not accessible to, but not specific to, a particular game. For example, the console routines may be called by any game routine.

Preferably, the game includes both maturity-restricted and unrestricted content 150. The unrestricted could be accessed by the user without regard to the user's maturity. However, the user may be prevented from seeing or interacting with the other content if the user is not sufficiently mature. Examples of potential age-restricted content includes blood in a fighting game, in-game movie sequences designed for certain ages, or difficult-to-defeat enemies or levels. Alternatively, the entire game program 165 may be maturity-restricted. The content may comprise data (e.g., images or sounds), instructions (e.g., “show blood” or “play yell”), or various combinations thereof.

The maturity level required to access the content 150 may depend and change with the content. For example, the realism of the violence seen when fighting a particular in-game character could be very low, medium or high depending on whether the user is a younger than a teenager, a teenager, or an adult, respectively.

One of the console routines comprises voice analysis routine 161. This routine analyzes recorded human speech and returns a value that represents the maturity reflected in the user's speech. For example, the value may indicate whether the user is likely to be a parent or child. The value may also indicate the user's likely age. Preferably, the value indicates whether the user has reached puberty. As is known to those of ordinary skill in the art, the fundamental frequency of a human's voice (often referred to as the person's “pitch”) is measurable and tends to decrease after puberty. Accordingly, tables of fundamental frequencies and their associated ages may also be used to determine a speaker's likely level of maturity. Voice analysis routine 161 uses these techniques or others to extract the fundamental frequency from human speech recorded in memory 140, compare the extracted frequency against a table of frequencies stored in memory 140, determine the user's maturity that is reflected in the user's speech, and then return a value indicative of that maturity. The returned value can then be used by the calling routine, such a routine in game program 165.

Data 145 may store user profiles 155 containing information about the users that use the console 105. Some of the information may be provided by the user, such as the user's name. Other information may be calculated, such as the user's maturity, as described below.

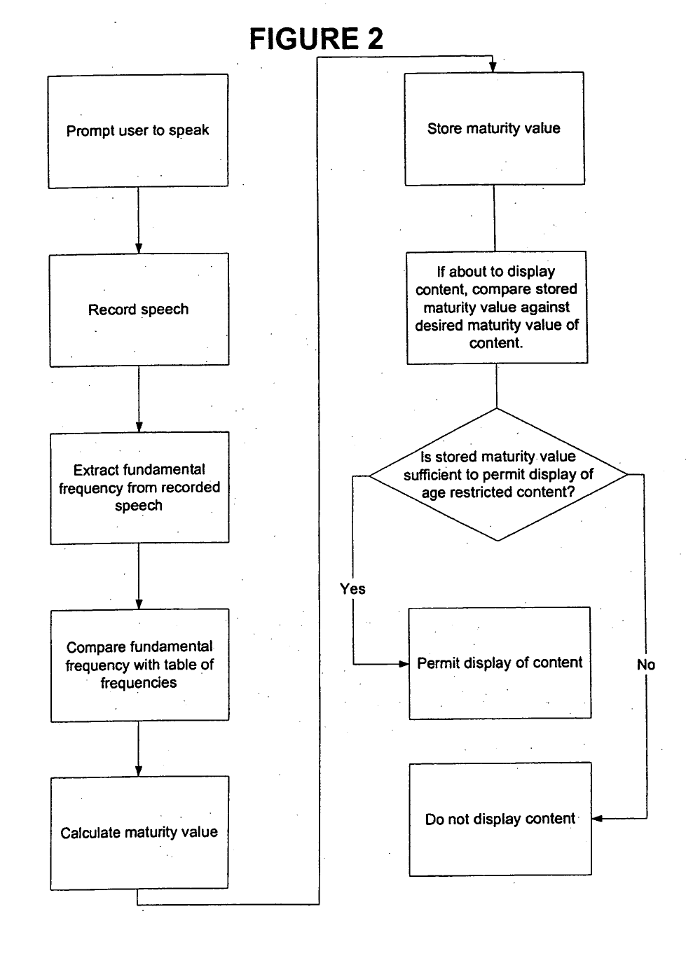

In addition to the operations illustrated in FIG. 2, an operation in accordance with a variety of aspects of the invention will now be described. It should be understood that the following operations do not have to be performed in the precise order described below. Rather, various steps can be handled in reverse order or simultaneously.

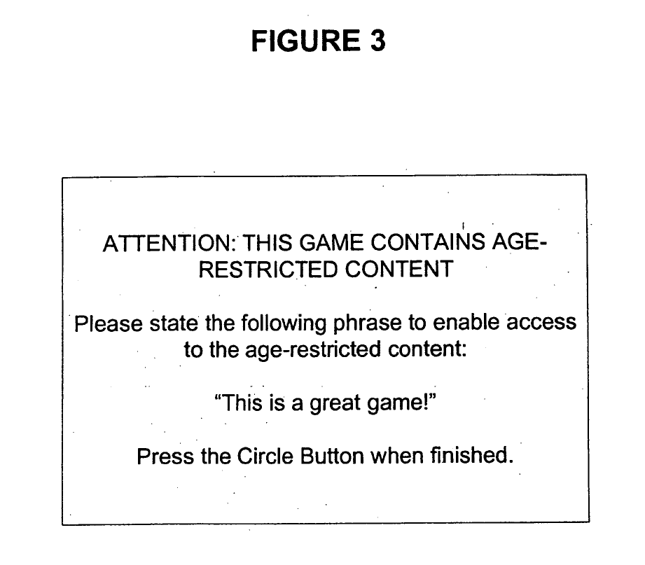

Upon execution of the game program 165 or sometime before or thereafter, the user 300 is prompted to speak a phrase. Preferably, the phrase is predetermined and designed to increase the accuracy of a maturity determination. The user's spoken phrase is picked up by microphone 110 and stored in memory 140. FIG. 3 illustrates just one example of a screen shot which prompts the user. Alternatively, the game console 105 may continuously monitor the microphone 110 for the purpose of insuring that the user has the requisite maturity level.

Voice analysis routine 161 analyzes the recorded speech 157 and returns a value indicative of whether the user is mature. After the user's maturity value 156 is calculated, it is stored in memory, such as in the user's profile 155. The maturity value may be a single value, such as a true/false value indicative of whether the speaker has likely reached puberty or not. The maturity value may also be another value, such as the most likely age of the speaker. The maturity value may also comprise a collection of values, such as a likely age range of the speaker. In addition, the maturity value may comprise information which is related, but not directly proportional to, the maturity of the speaker.

At one or more points during the execution of game program 165, the game program enables access to the content depending upon the maturity value of the recorded speech. For example, before playing an in-game movie which has some content intended for more mature viewers, game program 165 may check the maturity value 156 of the user. If the maturity value 156 is a true/false value which indicates whether the user has reached puberty, and if the maturity value indicates that the user is not mature, then portions of the in-game movie may be skipped. Because different portions of the content may be associated with different desired maturity values (for example, some portions of the same game may be reserved for only the most mature users while others are reserved for anyone other than very young children), the user's maturity value 156 may be checked repeatedly throughout the execution of the game.

The maturity value may used to provide users with the option, but not requirement, of viewing content which would otherwise be restricted. For example, if the maturity value indicates that the user is mature, then the user may be permitted to see realistic violence but would have the option of choosing not to, such as through an options screen. However, if the maturity value indicates that the user is not mature, then the user would not have the option of selecting realistic violence; for example, the realistic violence option on an options screen may be disabled.

Accordingly, in one aspect of the invention, a system and method is provided whereby access to content is restricted or permitted depending on the user's maturity, which is detected by analyzing the speech of the user.

Another aspect of the invention enhances the foregoing by also permitting the recorded speech to identify the user. In such a system, the user profile would include a phrase 158 recorded by the user. When the user starts the console or the game, the system not only extracts the user's maturity level from a spoken phrase, but also uses the spoken phrase to identify the profile 155 of the user. The user's pre-stored game preferences could then be used.

To the extent the user profile stores information about a user's current progress in a game, the use of voice-based passwords would prevent one user from overriding another user's information simply because they know the other user's password. In addition, the extracted maturity value can be compared with a maturity value entered by the user (or parent) and execution of the game halted if there is a discrepancy.

In yet another enhancement, a parent may use his or her voice to create the children's user profiles. The voice of the parent would then be required before maturity-restricted content was accessed.

As noted above, the system displays a phrase intended to be spoken by the user so that the user's maturity can be extracted. However, rather than simply selecting phrases which are intended to make it easy to extract a maturity level, the phrase may also be designed to use words that would be difficult for a young user to read and accurately pronounce. A text-to-speech algorithm could then be used to determine whether the user has accurately read the phrase; if not, then the user would be assumed to be a child and the content restricted accordingly. The phrase could be randomly selected from a list of phrases to prevent children from mimicking the phrase. The phrase may also comprise a question that is similarly intended to test the maturity of the user. The answer would be converted from speech to text and, if the answer is correct, then this would also be used as a factor to determine the maturity of the user along with maturity detected in the frequency of the speech.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims.

1. A method of providing access to content comprising:
receiving content;
receiving information related to speech spoken by a human speaker;
processing the speech information and generating a value related to the speaker's maturity detected in the speech; and
enabling access to the content dependant upon the maturity value.

2. The method of claim 1 wherein a portion of the content is maturity-restricted and a portion of the content is maturity-unrestricted, and wherein enabling access to the content comprises providing access to the maturity-unrestricted content and preventing access to the maturity-restricted content.

3. The method of claim 1 further comprising recording the speech spoken by the human speaker and storing the recorded speech in computer memory.

4. The method of claim 1 further comprising displaying a phrase to the speaker and wherein the speech spoken by a human speaker is the phrase.

5. A method of determining maturity comprising:
storing a speaker's speech in a memory;
calculating a value representative of the frequency of the speech;
executing a game with a processor, the game including content; and
permitting display of a portion of the content depending on the frequency value.

6. The method of claim 5 wherein the content portion is associated with a desired age and further comprising:
calculating a value based on the speaker's age indicated by the frequency value;
permitting display of the content portion if the speaker's age is not less than the desired age.

7. The method of claim 6 wherein the value based on the speaker's age represents a range of ages.

8. The method of claim 5 wherein the content portion is associated with desired maturity values further comprising:
calculating a value, based on the frequency value, related to whether the frequency value indicates that the speaker has reached puberty;
comparing the desired maturity value against the calculated value; and
permitting the display of the content portion depending on such comparison.

9. The method of claim 5 further comprising comparing the frequency value with a list of frequency values, wherein the listed frequency values are associated with different levels of maturity.

10. The method of claim 9 wherein the different levels of maturity represent the ages of the speaker in years.

11. The method of claim 9 wherein the different levels of maturity represent whether the speaker has reached puberty.

12. The method of claim 5 further comprising determining the speaker's identity based on the speech.

13. The method of claim 12 wherein the speaker's identity is determined by comparing the speech with previous speech stored by the speaker.

14. The method of claim 13 further comprising selecting user preferences based on the identify of the speaker.

15. A system for displaying content comprising:
a microphone;
a memory storing speech recorded by the microphone and content to be displayed;
a processor;
a display;
instructions executable by the processor wherein the instructions comprise: extracting a maturity value from the speech wherein the maturity value is related to the speaker's maturity reflected in the stored speech, and permitting the display of content based on the maturity value.

16. The system of claim 15 wherein the system is a game console.

17. The system of claim 15 wherein the system is general purpose computer.

18. The system of claim 15 wherein the instructions further comprising determining the fundamental frequency of the stored speech.

19. The system of claim 15 wherein the memory stores a table of frequency values, and the instructions further comprise extracting the maturity value by comparing the fundamental frequency with the table of frequency values.

20. A method of providing game content comprising:
executing game instructions wherein the game instructions display game content, the game content comprising age-restricted content and unrestricted content;
prompting a user to speak;
storing the user's speech;
processing the stored speech and generating a maturity value representing the maturity of the user reflected in the stored speech; and
permitting the user to access the age-restricted content depending on the maturity value;
permitting the user to access the unrestricted content regardless of the maturity value.
